(19) United States
(12) Patent Application Publication
(10) Pub. No.: US 2012/0060166 A1
(43) Pub. Date: Mar. 8, 2012

(54) Day management using an integrated calendar

(75) Inventors: Joseph M. Jardine, Bainbridge Island, WA (US); James Reynolds, Ashburn, VA (US)

(73) Assignee: LEFT COAST LOGIC LLC, Bainbridge Island, WA (US)

(21) Appl. No.: 12/876,194

(22) Filed: Sep. 6, 2010

(51) Int. Cl. G06F 9/50

(52) U.S. Cl. 718/104

(57) ABSTRACT

A method and system for day management using an integrated calendar is disclosed. A user inputs his time available during a period and enters details on time-specific events to be performed during that period. The system fetches information entered by user and stores the details in the integrated calendar. Tasks to be performed are stored on task list in order of priority as entered by the user. The system determines free time available with the user for performing the tasks by subtracting the time allocated for the events from the time available. Further, tasks are allocated time schedules by allocating that free time to the duration of each task, as per priority. If a task cannot be performed in a particular time slot within the time period, the task may be split into multiple smaller tasks and performed at different time slots that are available.

### TECHNICAL FIELD

The embodiments herein relate to task management applications and, more particularly, to task management in integrated calendars.

### BACKGROUND

Present day systems offer a number of applications for management of tasks, events, to-do list and so on. For management of tasks and events a number of programs are available on the internet such as Google calendar, Yahoo calendar and the like. Further, some internet sites offer calendar services, using which a user may be able to manage his tasks, events and schedules effectively. These applications allow the user to configure alerts for tasks, events, schedules, to-do list. The applications also allow the user to store, organize, and view variety of tasks, events and meeting dates and appointments that the user must complete or desires to complete within the specified time line. The drawback associated with the applications is that the applications do not allow the user to integrate tasks and events on calendars. Further, some personal planner systems provide the option of accommodating tasks and events in a calendar but none of them mention of integrating tasks and events inside the calendar.

The aforementioned applications send a notification to the user informing the user of the time the task is to be performed. Further, the notification may be in the form of an alert, a pop up in the form of a reminder or the like. The drawbacks associated with such applications are that they do not have any means to dynamically determine the time of availability of the user. As a result, there is a possibility that the user may have missed the notification, as the user may be busy attending some other event at the time the task notification alarms. Further, the user may not be able to take an action regarding the task as the user is stuck in attending the event.

Further, the task management in present day applications is static in nature i.e., they do not take into account updated information from the user and apply it to the task management. For example, there is no means to check for the free times, or availability of the user during a day and plan his tasks during his period of availability. Also, if a user makes any updates in his times of availability, there is no means to reschedule the tasks to be done depending on the updates from the user. In another example, if a user has 1 hour of time available and the task that he would like to pursue in this time takes 2 hours, there is no means to start performing the task and then carry forward the task to next time slot when the user may be free. The task manager does not dynamically schedule the tasks defined by a user by mapping his times of availability with the time required for completion of each task. The scheduling part has to be manually done by the user. This may be tedious and stressful process for the user as he may not have sufficient time to manually map his available times with the tasks to be completed. Also, tasks and events require time for completion and the calendar is an ideal means for representing time lines. However, none of the existing systems offer services to integrate the tasks and events inside the calendar to define such time lines to the user.

Furthermore, the available task management applications do not provide the user with flexibility to enter the preferable time for performing tasks in the list such as by dragging the task to a time slot on the calendar and the like. The options for entering times for the task are usually complex and not user friendly. Such applications do not check the times of availability of the user and update the user on the tasks that may be completed within the stipulated time period. Due to the aforementioned limitations present day task management applications are not very effective because they are divorced from the timeline and timed events that take place in, and in most cases dominate, the work day.

### SUMMARY

In view of the foregoing, an embodiment herein provides a method for day management using an integrated calendar. The method comprises the steps of defining amount of time available for work during a period, checking events that are already scheduled, calculating the time allocated for the events, determining the time available for performing prioritized tasks based on the scheduled events, determining tasks that are to be performed in the time slots available during the day in order of the priority and allocating the tasks that are to be performed during the period in the order of priority. The method further splits a task into multiple tasks if the task cannot be performed within a given block of free time. The method further recalculates time available for performing the prioritized tasks and assigning the tasks when a user either (a) updates the task list, (b) updates his event schedule, or (c) changes the working hours available during the current day. It then reallocates the tasks for the period when a user updates any of the above three items. The period is one of day, week or month. The method also prioritizes tasks based on the order of the tasks as entered by a user in the task list. The method also defines duration of the tasks by entering a duration time for the task by overriding the default time for the tasks provided in the task settings. The duration of the tasks by selecting default time for the tasks provided in the task settings. The method determines time available for performing prioritized tasks by subtracting time allocated for events from time available during the period. The user defines the overall time period as well as the time duration for each of the tasks through one of using a slider device for the former, and tapping on the options and entering an option (or accepting the default) for the latter.

Embodiments further disclose a computer system for day management using an integrated calendar. The system is adapted with means for defining the amount of time available for work during a period, checking events already scheduled by the user for the period, determining time available for performing prioritized task based on the scheduled events, determining tasks that are to be performed in the time available during the day in order of the priority and allocating the tasks that are to be performed during the period in the order of priority. The computer system is further adapted with means for splitting a task into multiple tasks that fit into smaller ‘free time’ blocks if the task cannot be performed in any one block of free time during the period. The computer system is further adapted with means for recalculating time available for performing the prioritized tasks and assigning the tasks when the user updates task list, the events schedule, or the overall time allocated to working for the given day. The computer system is also adapted for reallocating the tasks for the period when the user updates task list. The computer system is further adapted for determining time available for performing prioritized task by subtracting time allocated for events from time available during the period prioritizing the tasks based on the order of the tasks as entered by the user in the task list. The period as defined is one of day, week or month. The computer system is further adapted for defining duration of the tasks by entering a duration time for the task by overriding the default time for the tasks provided in the task settings. The computer system is also adapted for defining duration of the tasks by selecting default time for the tasks provided in the task settings. The computer system is adapted for defining the overall time period for performing both tasks and events during a given day through one of using a slider to change either the start time, of the day end time of the day, or both.

Also, disclosed herein is a computer program product for day management using an integrated calendar. The product defines amount of time available for work during a period, checks events already scheduled during the period, calculates time allocated for the events, determines time available for performing prioritized task based on the scheduled events, determines tasks that are to be performed in the time available during the period in order of the priority and allocating the tasks that are to be performed during the period in the order of priority. The computer program product further comprises of splits the task into multiple tasks if the task cannot be performed in the time available time during the period and recalculates time available for performing the prioritized tasks and assigning the tasks when a user updates task list. The computer program product also reallocates the tasks for the period when a user updates task list. The computer program product prioritizes the tasks based on the order of the tasks as entered by the user in the task list. The period is one of day, week or month. The computer program product further defines duration of the tasks by entering a duration time for the task by overriding the default time for the tasks provided in the task settings. The computer program also defines duration of the tasks by selecting default time for the tasks provided in the task settings. The computer program product defines the time period and time duration for the tasks through one of using a slider, tapping on the options and entering an option. The computer program product determines time available for performing prioritized task by subtracting time allocated for events from time available during period.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 is a flow chart depicting the process of defining a task, according to an embodiment as disclosed herein;

FIG. 2 is a flow chart depicting the process of splitting a task into multiple tasks, according to an embodiment as disclosed herein;

FIG. 3 is a flow chart depicting the process of calculating and allocating tasks in available free time, according to an embodiment as disclosed herein;

FIG. 4 is a flow chart depicting the process of reordering tasks, according to an embodiment as disclosed herein;

FIGS. 5a and 5b are flow charts depicting the process of updating tasks, according to an embodiment as disclosed herein;

FIG. 6 is a flow chart depicting the process of adding an event, according to an embodiment as disclosed herein;

FIG. 7 is a flow chart depicting the process of updating an event, according to an embodiment as disclosed herein;

FIG. 8 is a snapshot depicting the integrated calendar settings, according to an embodiment as disclosed herein;

FIG. 9 illustrates additional default settings for calendars available to the user, as depicted in FIG.8 according to an embodiment as disclosed herein;

FIG. 10 illustrates a snapshot for event options, according to an embodiment as disclosed herein;

FIG. 11 illustrates a snapshot for event edit, according to an embodiment as disclosed herein;

FIG. 12 illustrates a snapshot for adding task, according to an embodiment as disclosed herein;

FIG. 13 illustrates a snapshot for updating a task, according to an embodiment as disclosed herein;

FIG. 14 is a snapshot depicting the task list with slider, according to an embodiment as disclosed herein;

FIG. 15 is a snapshot depicting reordering the task list, according to an embodiment as disclosed herein; and

FIG. 16 is a snapshot depicting splitting tasks in between events, according to an embodiment as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

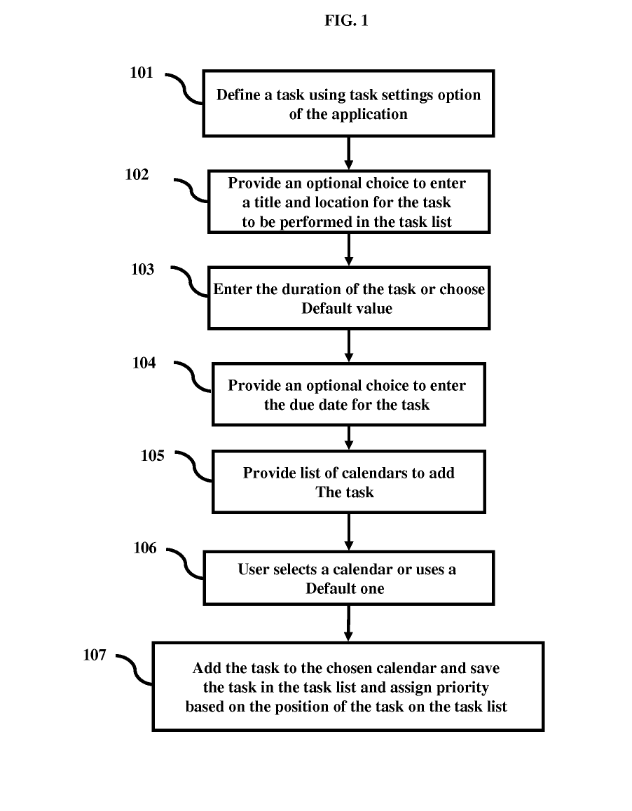

The embodiments herein disclose a method for managing the tasks of a user by integrating his tasks and events into a calendar Referring now to the drawings, and more particularly to FIGS. 1 through 16, where similar reference characters denote corresponding features consistently throughout the figures, there are shown embodiments.

A method and system for day management using an integrated calendar is disclosed. The method employs a mechanism wherein a user inputs his time available during a specific day for work. Work may be defined as time available for both tasks and events. Further, the user enters his events, and schedules of the events for the day. In an embodiment, the time available may be defined as period, where period may imply a day, couple of days, and week and so on. The user then enters the tasks that he would like to perform, also details of the tasks such as the time duration that each task would require, the location, start date, due date and so on may be input by the user. In an embodiment, event may be a meeting, presentation, discussion with team members, lunch and so on. Events are schedules that may be specific for a particular day (and time) or may repeat on a periodic basis. The user may also configure the settings of the event to repeat the event at a pre-defined period of time for example, if the discussion with team members is held everyday at 12:00 PM to discuss the updates of the ongoing project, the user may configure the event ‘discussion with team members’ for everyday 12:00 PM. Further, tasks may be jobs that a user wishes to perform whenever he finds time from his schedules such as events or the like. Examples of tasks include update website, work on the blog, leave the car at service station, and mow lawn and so on. Time for tasks are allotted only when the user has some free time in his available time apart from his events. The tasks are maintained in the task list in the order of priority as entered by the user. At any point of time, the system does not modify the priority order of the tasks in the task list. The order of priority is always maintained and tasks are allocated in the free time of the user only in the order of priority. If a task does not fit in the time available, the task may be split up into multiple small tasks to be performed at different time slots that are available.

Once the details are input by the user, the integrated calendar accesses the details of the user. The integrated calendar refers to the time available for that particular user during the period (day), the start and end time(s) he has defined for any event(s) and the tasks that are in the task list, together with the estimated duration for each task. The duration may be either default or manually updated. The integrated calendar then determines the total time (free time) that may be assigned for the tasks during the period. The time for tasks may be determined by subtracting the time allocated for events from the total available time for the day as input by the user. The integrated calendar then determines the number of tasks that can be assigned in the obtained free time in the order of priority from the task list. In an example, if the total available time entered by a user is from 10:00 AM to 5:00 PM the total time duration available to the user is 7 hours. The integrated calendar then determines the free time for tasks by subtracting time of the events. If the free time comes up to 2 hours and the time is available in slots of 1:00 PM-2:00 PM, 3:00 PM-3:30 PM and 4:30 PM-5:00 PM. The integrated calendar may allocate the 2 hours duration as flows for performing the tasks, during 1:00 PM-2:00 PM update website, 3:00 PM-3:30 PM work on blog, 4:30 PM-5:00 PM leave the car at the service station. Note that the tasks are allocated in the order specified by the user in the task list i.e., in the order of priority.

In an embodiment, if a task does not fit in the free time, the task may be split into multiple smaller tasks to carry forward the tasks over different time slots. For example, if the task ‘update website’ cannot be completed in an hour the task may be split into duration of 1:00 PM-2:00 PM and 3:00 PM-3:30 PM depending on the duration allocated for the task.

FIG. 1 is a flow chart depicting the process of defining a task, according to an embodiment as disclosed herein. In the embodiment herein, the time period used is a day. However, the use of day is meant only for the purpose of illustration and does not limit the scope of application. A user who employs the integrated calendar application enters the details of the task in the task menu of the application. The details may be entered by using a tap option on the screen of the application or using a slider option. The user goes to the task settings options and defines (101) the tasks to be performed. For example, the user may enter a list of tasks such as update website, work on the blog, leave the car at service station, mow the lawn and so on. The user may want to input the task ‘update website’ then user may enter (102) the title of the task ‘update website’ in the title column and the location for the task is entered. Further, note that the option of entering the title and location may be optional and not a mandatory requirement. The user then enters (103) the duration of time required for performing the task for example, to update the website the duration required may be 1 hour. The user can also accept a default duration that is established by the user under “general settings.” The integrated calendar then asks the user to input due date if any, for the task. The user may enter (104) the due date as Wednesday, August 2010/08/11. The user may be offered (105) a list of calendar options to choose from or he may select an available default value. These calendar options are used for delineating different task and event types (such as Home, Work, Personal, etc) and are color coded. They are also used for synchronizing tasks with other calendar and task applications such as online calendaring services offered on the internet. User then enters (106) his choice or selects the default one. By default, the integrated calendar assigns the default calendar option to the task, but the user may assign a different calendar option. Further, the details of the user may be added (107) to the calendar chosen by the user and the tasks may be saved in the task list. The tasks are assigned priority in the order of their input into the task list by the user. Further, the priority of the task list in not altered at any time by the application. Tasks are allocated only in the order of the priority in the task list and no overriding of priority is allowed. The various actions in method 100 may be performed in the order presented, in a different order or simultaneously. Further, in some embodiments, some actions listed in FIG. 1 may be omitted.

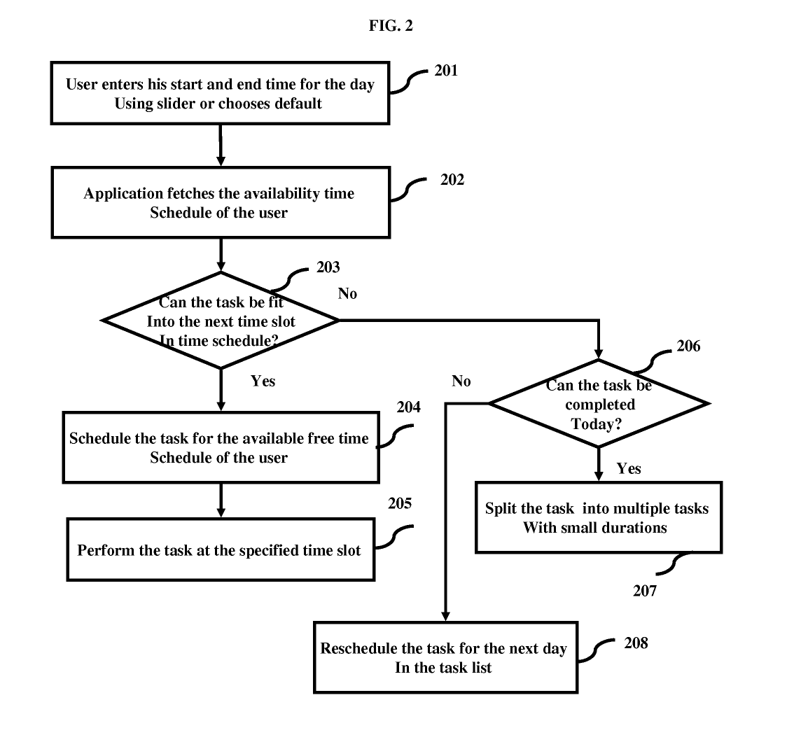

FIG. 2 is a flow chart depicting the process of splitting a task into multiple tasks, according to an embodiment as disclosed herein. In the embodiment herein, the time period used is a day. However, the use of day is meant only for the purpose of illustration and does not limit the scope of application. Further, the integrated calendar application may be implemented on a device such as a mobile phone, a laptop, desktop or the like. When a user accesses the application, he enters his time available for the day. The time is entered (201) in the form of start time for the day and the end time for the day. The time may be entered by using the slider or by choosing a default value available in the general settings. The application computes (202) the total available time of the user for the day, based on the inputs of start time and end time of the user. In an example, the user may enter start time as 11:00 AM and end time as 5:00 PM. The application determines that the total available time for the day with the user is 7 hours. Further, a check (203) is made if the task from the task list can be allocated in the next available time slot of the user. During the check a mapping is done with the time duration required to perform the task against the free time available for doing the task. In case, the task can be allocated in the next available time slot, then the task is scheduled (204) for the available free time of the user. The task may be performed (205) at the next available free time slot of the user. On the other hand, if the task requires more time (the duration of task defined by the user is more than the free time available) than is available in the next free time slot, then a check (206) may be made if the task can be completed in that time slot and any subsequent free time slots occurring during the defined period. For example, if the task requires 3 hours for completion and the total free time available during the day is 3 hours but is split over two different time slots, then the task may be completed during the day in the different time slots. If the task may be completed during the day, the task may be split (207) into multiple smaller tasks spread over different time slots to be completed. On the other hand, if the task cannot be completed during the day, then the task may be rescheduled (208) by the application for the next day depending on the availability of the free time of the user for that particular task. The various actions in method 200 may be performed in the order presented, in a different order or simultaneously. Further, in some embodiments, some actions listed in FIG. 2 may be omitted.

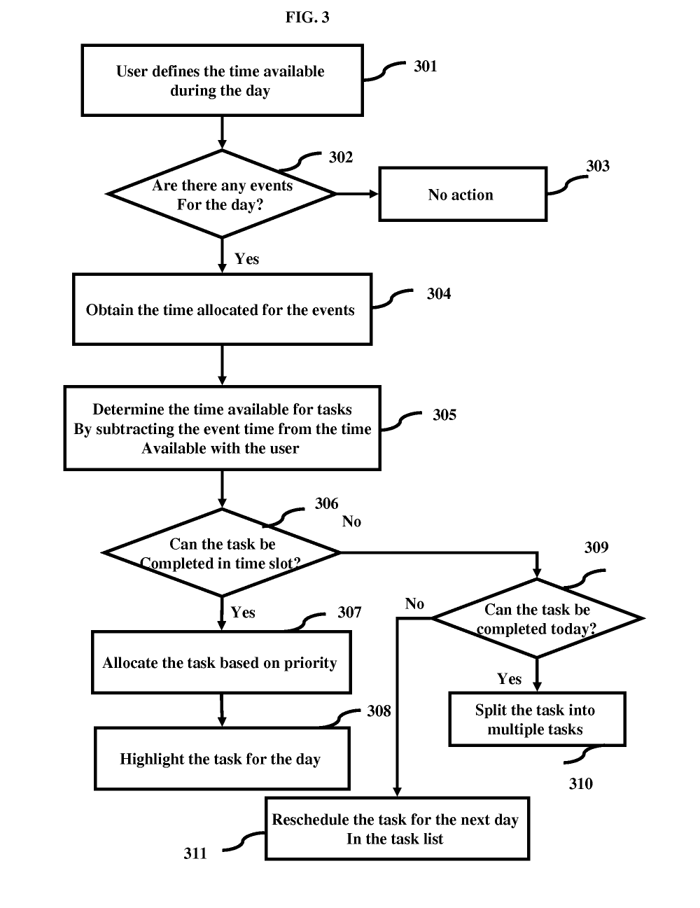

FIG. 3 is a flow chart depicting the process of calculating and allocating tasks in available free time, according to an embodiment as disclosed herein. In the embodiment herein, the time period used is a day. However, the use of day is meant only for the purpose of illustration and does not limit the scope of application. A user specifies (301) the time available during the day by entering the start time and end time for the day. The integrated calendar then makes (302) a check if there are any events entered by the user for the day. If there are no entries of any events for the day then no action is taken (303) and the time available is allocated for the tasks from the task list. If there are events for the day, the application fetches (304) the time allocated for the events during the day. The application then determines (305) the remaining free time available with the user for performing the tasks from the task list. The free time for tasks is determined by subtracting the time allocated for the events from the total time available with the user for the day. Further, a check is made (306) if the task can be completed in the determined free time of the user. During the check it is found if the free time obtained for the tasks matches with the duration specified for the tasks in the task list. If the task can be completed in the obtained free time (available time slot) the task is allocated (307) for that particular free time. The allocation is based on the order of the tasks in the task list i.e., the order also sets the priority defined by the user when he enters the task into the task list. In addition, in the Task List, the tasks that can be performed during the day are highlighted (308) or otherwise demarcated for ease of reference. On the other hand, if the task cannot be completed in the immediate time slot available a check (309) is made if the task can be completed during any other time slots that are available during the day. If the task can be completed during the day, the task may be split (310) into multiple small tasks that can be allocated over the free time slots available during the day. In case, the task cannot be completed during the day as the time required for the task may be more than the free time for the day the task may be rescheduled (311) for the next day depending on the availability of the user. For ease of reference, in the Task List, tasks that cannot be performed during the day are faded or otherwise demarcated. The various actions in method 300 may be performed in the order presented, in a different order or simultaneously. Further, in some embodiments, some actions listed in FIG. 3 may be omitted.

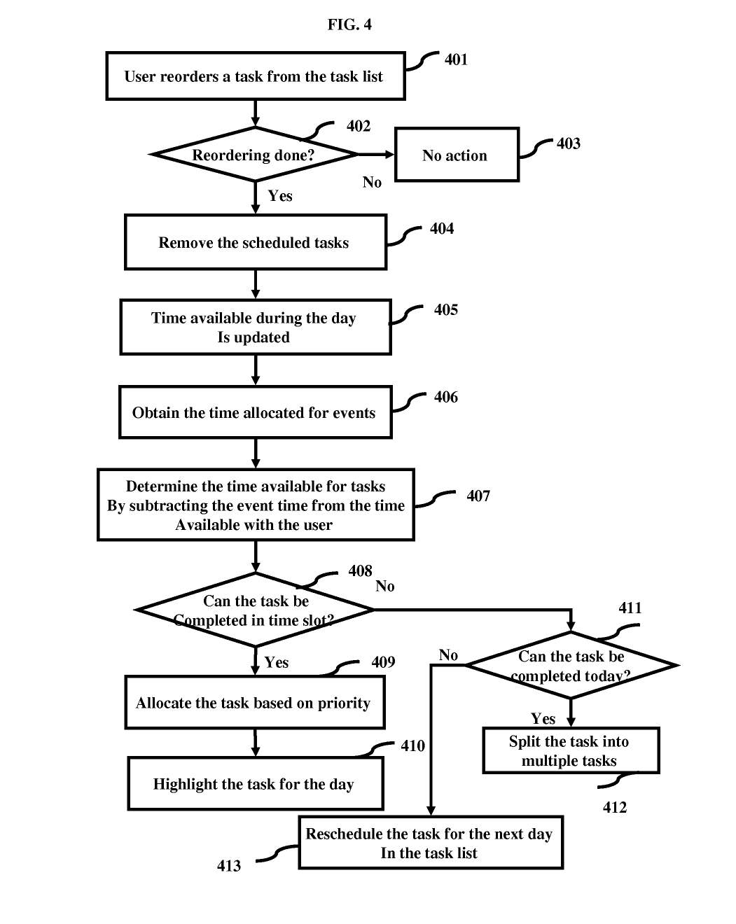

FIG. 4 is a flow chart depicting the process of reordering tasks, according to an embodiment as disclosed herein. In the embodiment herein, the time period used is a day. However, the use of day is meant only for the purpose of illustration and does not limit the scope of application. A user using the integrated calendar application wishes to make changes in the task list that he last entered. Consider the user wants to reorder (401) the tasks entered by him in the task list for example, place the task ‘work on blog’ first in the list followed by ‘update website’ in the list. The user can drag the task ‘work on blog’ form the task list and place it at the position of ‘update website’, so that ‘work on blog’ becomes the first in the list with highest priority. The integrated calendar application logic performs decision (402) whether the task list is reordered or modified or updated. In case there is no change in the task list no action may be taken (403). If there is change in the task list, the application removes (404) the scheduled tasks from placement in the Calendar and clears all the allocation done for the tasks during the time slots for the day. Further, the user updates (405) the time available during the day for example, earlier the user may have provided 7 hours during the day, on updating the user may provide only 5 hours for the day. The application then determines (406) the time the user has allocated for the events for the day. Further, the application determines (407) the free time available with the user for performing the tasks from the task list. The free time for tasks is determined by subtracting the time allocated for the events form the total time available with the user for the day. Further, the application determines (408) if the task can be completed in the determined free time of the user. During the check, it is found, if the free time obtained for the tasks matches with the duration specified for the tasks in the task list. If the task can be completed in the obtained free time (available time slot) the task is allocated (409) for that particular free time and placed into the Calendar. The allocation is based on the order of the tasks in the task list i.e., the order also sets the priority defined by the user when he enters the task into the task list. In addition, the tasks that can be performed during the day are highlighted (410). On the other hand, if the task cannot be completed in that particular free time a check (411) is made if the task can be completed during the free time available for the whole day. If the task can be completed during the day, the task may be split (412) into multiple small tasks that can be allocated over the free time slots available during the day. In case, the task cannot be completed during the day as the time required for the task may be more than the free time for the day the task may be rescheduled (413) for the next day depending on the availability of the user. In an embodiment, the order in the task list is determined by the user and can be done either manually, as described above, or automatically, for example by sorting tasks by “Due Date,” “Creation Date” or some other similar sort or rank criteria. The various actions in method 400 may be performed in the order presented, in a different order or simultaneously. Further, in some embodiments, some actions listed in FIG. 4 may be omitted.

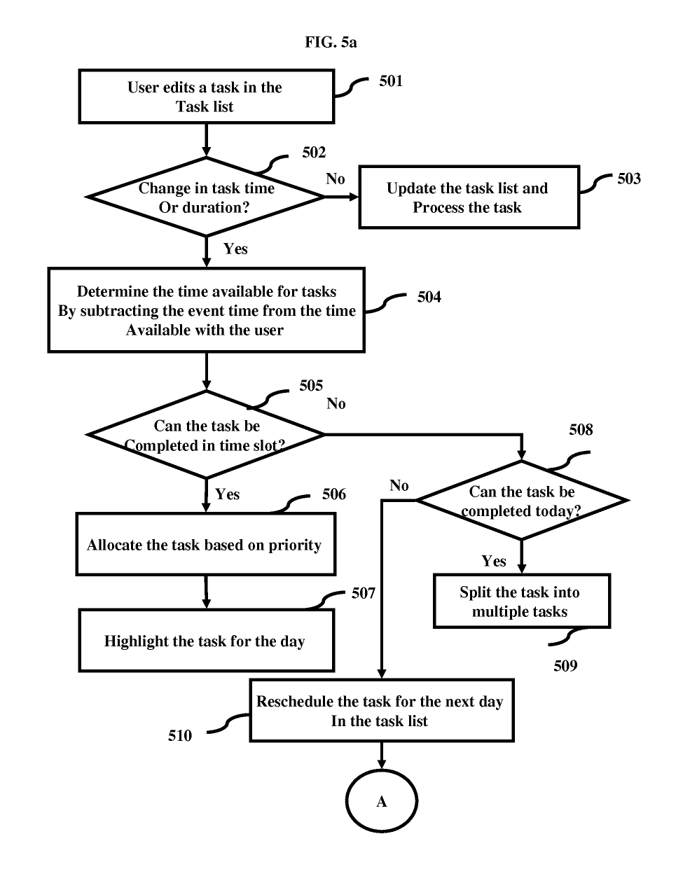

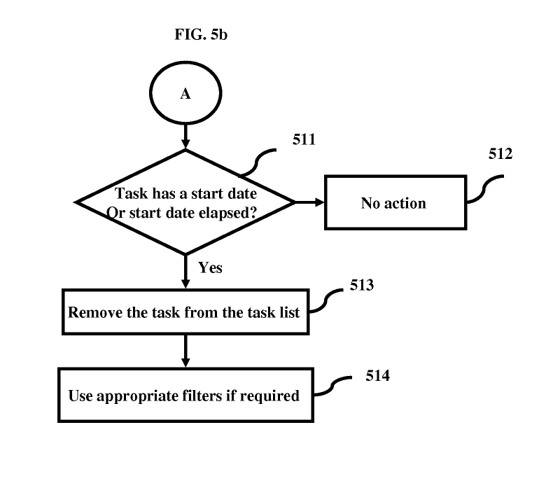

FIGS. 5a and 5b are flow charts depicting the process of updating tasks, according to an embodiment as disclosed herein. In the embodiment herein, the time period used is a day. However, the use of day is meant only for the purpose of illustration and does not limit the scope of application. The user employing integrated calendar application edits (501) a task from the task list. The edit may include, but is not limited to, changing the name of the task, location of the task, start and/or due dates of the task, repeat functions, alert settings, calendar category, or duration of time allocated for the task in the task list. A check (502) is made if there is any change in the task time duration. If there are no edits to the task duration then the task list is saved (503) and the process continues. In case there is change in the time duration of a task the application recalculates (504) the free time available for doing the task by subtracting the available time indicated by the user with the time allocated for the events. Further, the application determines (505) if the task can be completed in the recalculated time slot. If the task can be completed, the task is allocated (506) for the free time slot. The tasks that are allocated for completion on that day may be highlighted (507). In case the task cannot be allocated in the recalculated free time slots a check (508) is made if the task can be completed during the day. If the task can be completed during the free time available for the day the task may be split (509) into smaller tasks. On the other hand, the task cannot be completed during the day as the time required for the task may be more than the free time for the day the task may be rescheduled (510) for the next day depending on the availability of the user. Additionally, the application determines (511) if the task has a Start date and, if so, whether that start date has already occurred or not. If the Start date has not yet occurred, then, optionally, as determined in the default settings, the software may remove (513) the task from the Task List until the current date matches or exceeds the Start Date. In this case, because the Task has been temporarily removed from the Task List, it is also removed from calculation for free time. If the task time has not been entered or if the start time of the task is far then no action is taken (512) until the task time nears. Additionally, tasks may be removed from the task list due to any other types of filters (514). For example, “show only tasks that belong to the Work Calendar category,” or “show only tasks that belong to the Home Calendar category,” or “show only tasks that relate to a specific Tag or Keyword”, or “show only tasks that are overdue.” The various actions in method 500 may be performed in the order presented, in a different order or simultaneously. Further, in some embodiments, some actions listed in FIG. 5 may be omitted.

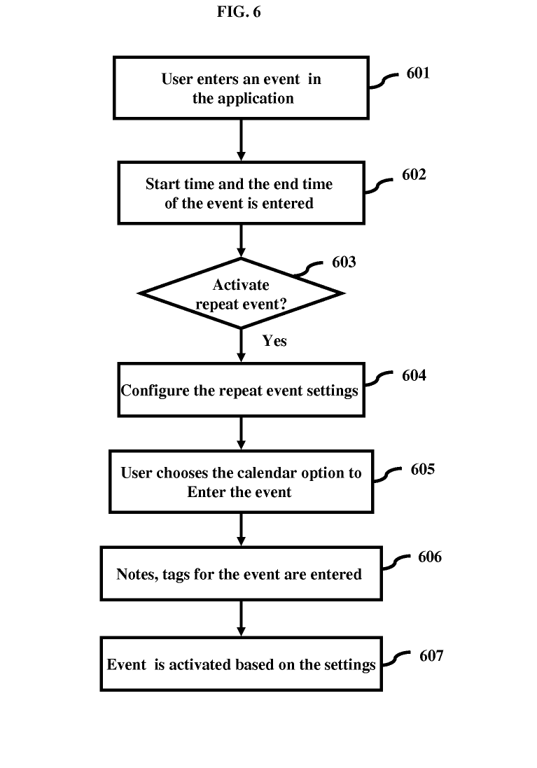

FIG. 6 is a flow chart depicting the process of adding an event, according to an embodiment as disclosed herein. In the embodiment herein, the time period used is a day. However, the use of day is meant only for the purpose of illustration and does not limit the scope of application. A user enters (601) an event in the integrated calendar application on the events options. The application offers (602) options to enter the start time and the end times of the event. The application then checks (603) if the user wishes to set repeat option for the event. For example, for events such as meetings with the team and so on that are held on an everyday basis the repeat event option may be activated. In such cases, repeat event options may be provided to the user to configure (604) the event repeat settings. The user may enter options as repeat event: weekday: everyday; time: 10:00 AM. The user is then provided with the calendar options in order to make an entry of his event. The user chooses (605) a suitable calendar option in which the event is entered and saved. Further, any notes, tags that are applicable for the event are entered (606). The event is then activated based on the settings configured by the user. Note that the steps involved in the entry of the event may be performed by using the slider provider or at the tap of a finger on the screen and the process is very user friendly. Note that certain types of Events are not time related and therefore are not included in the calculation of remaining time available for tasks. Such events are referred to as “All Day Events” and may include, for example, “John's Birthday” or “Christmas Day” or “Family Vacation” (which is a multiple-day All Day Event). The various actions in method 600 may be performed in the order presented, in a different order or simultaneously. Further, in some embodiments, some actions listed in FIG. 6 may be omitted.

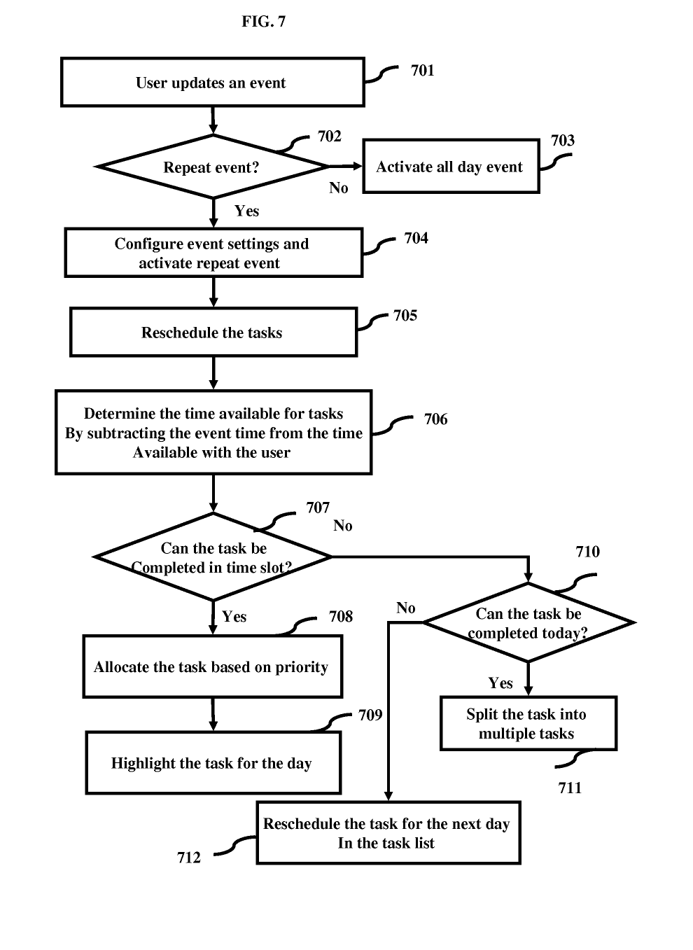

FIG. 7 is a flow chart depicting the process of updating an event, according to an embodiment as disclosed herein. In the embodiment herein, the time period used is a day. However, the use of day is meant only for the purpose of illustration and does not limit the scope of application. When a user wishes to make (701) updates in the event last entered by him, the user goes to edit event option. The user then makes the required updates for the event such as time of the event, location, replacing an event with new one and the like. A check (702) is made if the event is an all day event All Day Events for example, “John's Birthday” or “Christmas Day” or “Family Vacation” (which is a multiple-day All Day Event). If the event is an all day event then corresponding setting for all day event is activated (703). In case the event is a repeat event that is to be repeated at pre-defined intervals, details on the pre-defined intervals are configured (704) and the event is activated. Once updates on the events are made the task list in to be rescheduled (705) in order to allocate new times for the tasks. The task list needs to be rescheduled as some of the events may take longer time duration than that entered the last time and thus the free time for performing the tasks may vary accordingly. Further, the application determines (706) the free time available with the user for performing the tasks from the task list. The free time for tasks is determined by subtracting the time allocated for the events form the total time available with the user for the day. Further, a check is made (707) if the task can be completed in the determined free time of the user. During the check it is found if the free time obtained for the tasks matches with the duration specified for the tasks in the task list. If the task can be completed in the obtained free time (available time slot) the task is allocated (708) for that particular free time. The allocation is based on the order of the tasks in the task list i.e., the order also sets the priority defined by the user when he enters the task into the task list. In addition, the tasks that can be performed during the day are highlighted (709). On the other hand, if the task cannot be completed in that particular free time a check (710) is made if the task can be completed during the free time available for the whole day. If the task can be completed during the day, the task may be split (711) into multiple small tasks that can be allocated over the free time slots available during the day. In case, the task cannot be completed during the day as the time required for the task may be more than the free time for the day the task may be rescheduled (712) for the next day depending on the availability of the user. The various actions in method 700 may be performed in the order presented, in a different order or simultaneously. Further, in some embodiments, some actions listed in FIG. 7 may be omitted.

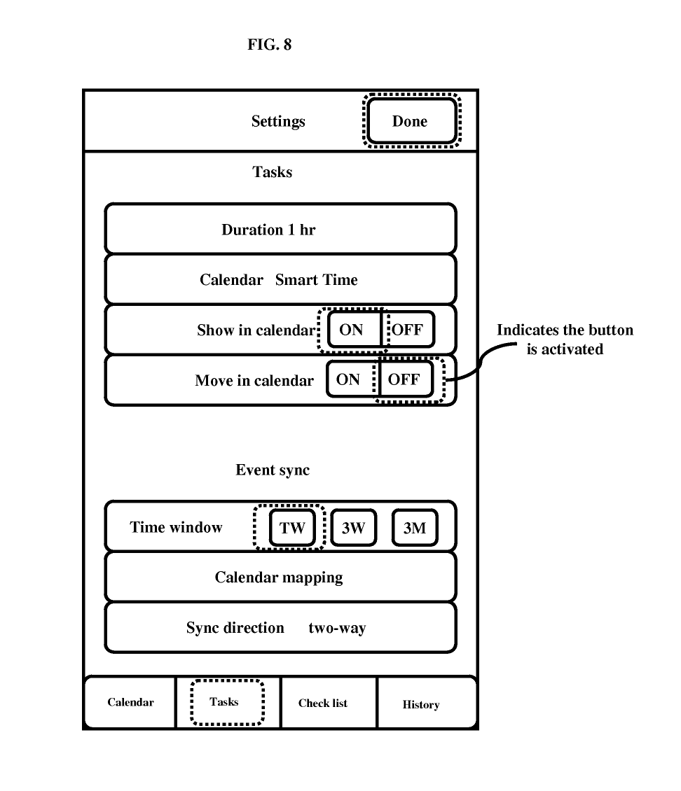

FIG. 8 is a snapshot depicting the integrated calendar settings, according to an embodiment as disclosed herein. The snapshot indicates how a user makes default calendar settings on the application. When the user goes to the settings menu he gets the following view. Under the tasks option the user is provided with options such as default duration, calendar, show in calendar and move in calendar. Duration option allows the user to enter the duration for a task. The default duration of all tasks may be entered by just tapping on the options or sliding through the option. In the corresponding snapshot the user has entered the default duration for all new tasks as 1 hour. The calendar option allows the user to select the default calendar name that he would like to put his task list into, from a list of default or user-defined calendar names. The default calendar to be used for all new tasks and events created by the user in this case is “smart time” calendar. The “show in calendar” option allows the user to provide the display of the task list in the calendar, integrated into the time slots that have been allocated. The user may choose to put this option on or off. Putting the option “Off” will remove tasks from display in the calendar, but will not remove events from calculation in the determination of time allocated to those tasks in the Task View. “Move in calendar” option allows a user to move tasks in the calendar by manually dragging them with a fingertip or mouse. The action of moving a task in the calendar forces the task into a specific time and therefore automatically converts that task into an event. When a task is converted into an event, it is removed from the task list and instead becomes a part of the calculation of event times that are used to determine the remaining time that can be allocated to tasks. The user may convert this event—or any event, for that matter—back into a task simply by going to the edit screen and selecting “task” rather than “event.” Converting an event into a task places it into the task list and removes that event from the Calendar. The then-created task may or may not show up in the Calendar as a task, depending upon its priority in the task list and whether time can be allocated for the task. The user can choose to active or deactivate the option by selecting the on or off. Deactivating the option keeps the user from converting tasks into events by moving them.

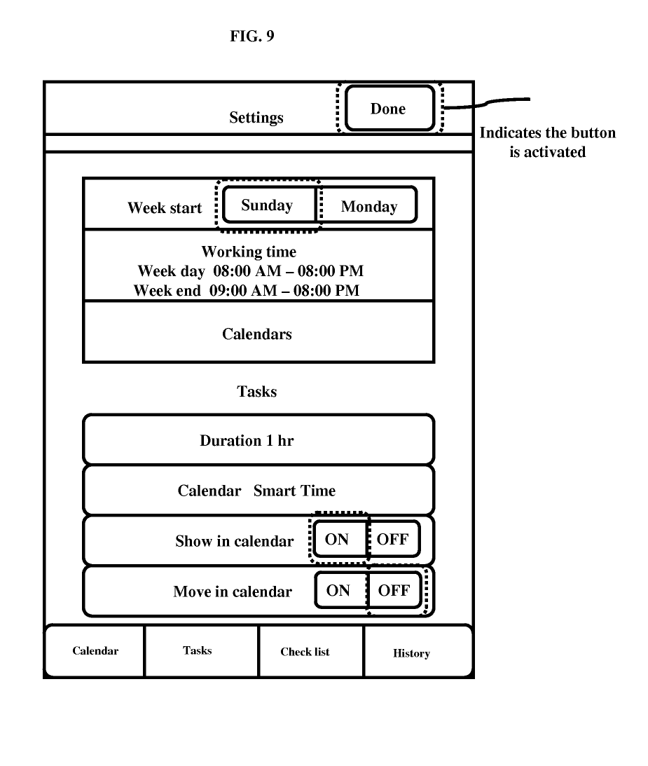

FIG. 9 illustrates additional default settings for Calendars available to the user, as depicted in FIG.8 according to an embodiment as disclosed herein. When the user goes to the default settings option he is provided with the view of the following snapshot in addition to the view from FIG. 8. The user chooses week start at Sunday and thus Sunday is highlighted in the snapshot. The user is provided to input the working times during the week days and weekend. The user enters 8:00 AM to 8:00 PM during week day and 9:00 AM to 8:00 PM during weekend. These determine the default working hours for calculating total working time for a given day, and can be updated and changed quickly and easily by the user by adjusting the slider bar from the task view.

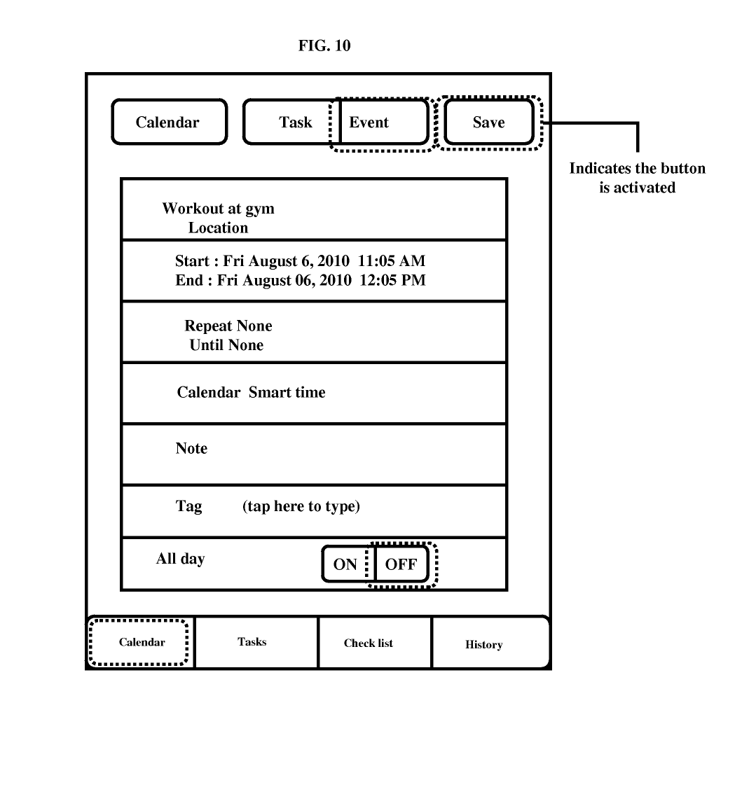

FIG. 10 illustrates a snapshot for event options, according to an embodiment as disclosed herein. When a user wants to add any event into the calendar the user is provided with the view as depicted in the snapshot. As the user makes an entry for an event, the event option is activated (indicated by dotted box). The event name is ‘work out at the gym’ and the location of the event that may be entered in the location option. The start date and time of the event are entered as Start: Fri August 6, 2010, 11:05 AM and the end date and time is entered as End: Fri August 06, 2010 12:05 PM. The repeat option allows the user to configure event repetition. The event may be chosen to repeat at specified times and ‘until’ option indicates the time period or the date until which the event is to be repeated. By default the new event is associated with the default calendar selected in the default settings but the user may choose from any of the other existing calendars. Every new event, and task, must be associated with a calendar category. Also, any notes and tags related to the event may be defined in their respective columns If the event is an all day event the option of ‘all day’ may be activated else the option is deactivated. The listed choices and settings may be saved by selecting the save button of the application. In an embodiment, the user may be provided options to repeat the event daily, weekly, months or yearly and also the number of times the event is to be repeated.

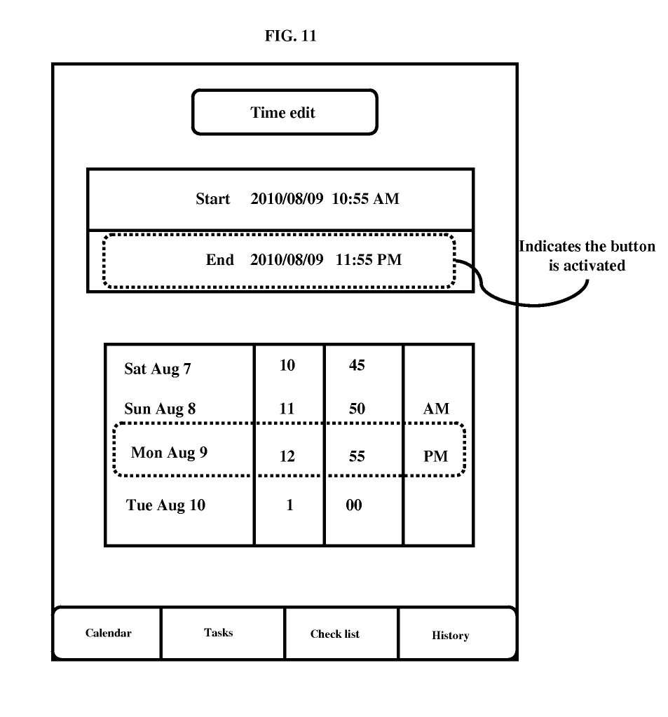

FIG. 11 illustrates a snapshot for event edit, according to an embodiment as disclosed herein. A user who wishes to edit the entries made in the event list can do so by accessing the event edit option on the application. As depicted in the snapshot if the user wishes to edit the end time of the event the user may choose the end time option and perform the edit. The edit may be done by scrolling through the options provided on the list or tapping on the options. In another embodiment, the user may also be provided with options to enter the end time. The window below provides a view of the dates and times. Using this window the user may perform the edit options. In the example, the user performs edit on Monday Aug 9, 12 55 PM option. The user can edit the date and time by sliding through the individual options for example, when he taps on Monday the user is provided with options of the days to an the can slide through the days to activate the setting. When he taps on August, he is provided with options of the months and he can slide through the months to activate the setting and so on. In similar manner all edits may be performed easily by the user.

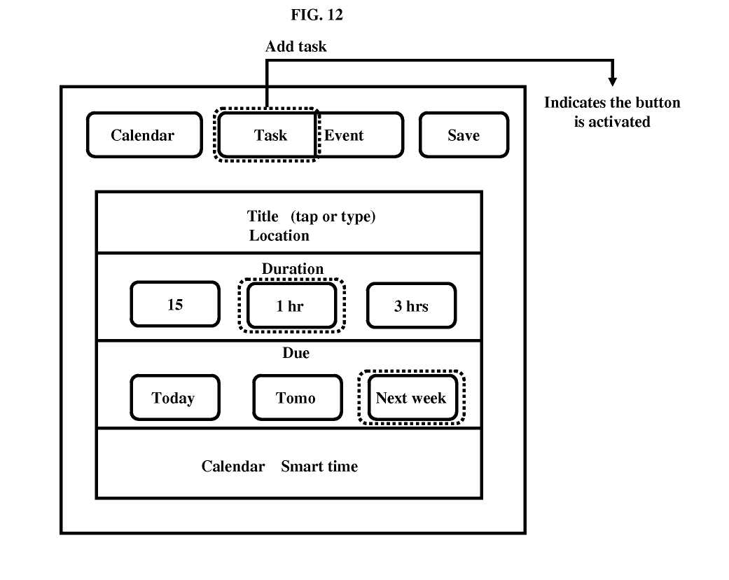

FIG. 12 illustrates a snapshot for adding task, according to an embodiment as disclosed herein. When a user wishes to add a task into the task list the view is as provided in the snapshot. The user enters the task name and, optionally, the location of the task. The entry may be made by tying or tapping on the screen. The user may accept the default duration of a task as defined under general settings, but is also provided with option to enter the duration of the task either by selecting from a list of common task durations, shown in the figure as “15 mins, 1 hr, 3 hrs” or by manually inputting or selecting a more specific duration. Here, the user selects 1 hour duration. Further, the due date if any, for the task may also be entered by choosing options such as today, tomorrow and next week. As with events, tasks must be associated with one calendar. The user may accept the default calendar, or may choose from the list of calendars. In an example, if a user enters the task as car wash and the location as home. The user may enter the time required as 30 minutes, due as next week, and it is associated with the “SmartTime” calendar category. Once the settings are done the settings may be stored and the tasks are activated.

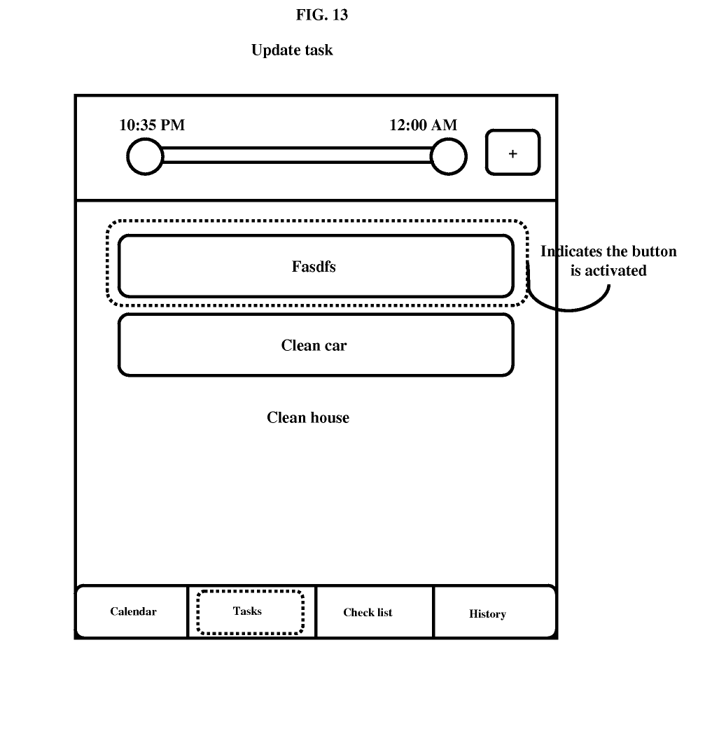

FIG. 13 illustrates a snapshot for updating a task, according to an embodiment as disclosed herein. A user may choose to update a task from the task list. The task to be updated is selected as shown in the snapshot. Further, by tapping on the task the user is provided with exact same options on the details of the task as shown in FIG. 12 such as the duration of the task, due date and so on. The user then performs updates on the particular task chosen. In an example, if the duration allotted by the user is 30 min in his initial settings and the user wants to update the duration to 45 min, the user may choose to do so by using the option provided for updating task. Further, if the user wishes to update the available time entered by him the user can do so by sliding the time slider provided at the top. The slider indicates the user configured time from 10:35 AM to 12:00 PM. If the user wants to allocate the time from 11:00 AM to 12:00 PM he can change the position of the slider to indicate the start time as 11:00 AM. The application then updates the time available to 1 hour from the earlier setting of 1 hour 30 min. In another embodiment, the application also updates the time available with the user for doing the tasks as the day passes. The user can view the time left on the position of the slider. Multiple tasks may also be selected and a limited number of edits made to those selected tasks as a group. This may include “mark done”, “delete”, “mark as pinned.”

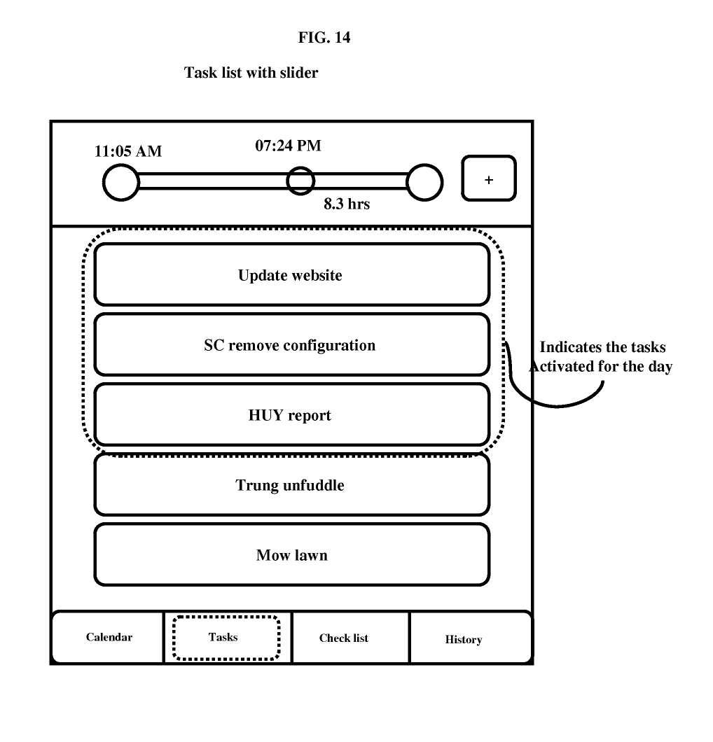

FIG. 14 is a snapshot depicting the task list with slider, according to an embodiment as disclosed herein. In the embodiment herein, the time period used is a day. However, the use of day is meant only for the purpose of illustration and does not limit the scope of application. The snapshot depicts the view of the task list with the tasks. The task list comprises of tasks such as update website, remove configuration, HUY repot, trung unfuddle and mow lawn that are entered in the order of their priority. The priority of the tasks is in the order of “update website” at the highest, followed by “SC remove configuration”, “HUY report” and so on. Further, the tasks selected for the day i.e., the tasks that may be fit into the time slots and assigned for the day are chosen and highlighted by a rounded rectangular box around them, or similar demarcation. Tasks such as “trung unfuddle” and “mow lawn” cannot be fit in the free time for the day and hence they are not highlighted. Further, the slider on top indicates the available time indicated by the user. The motion of the slider indicates the time that has elapsed since the start time. For example, if the start time is set as 11:05 AM the current position of the slider indicates the current time is 7:24 PM and the total time duration allocated was 8.3 hours. In the example, there are two ways to allocate time for “Trung unfuddle” to be done during the current day. The user can manually drag that task up into the “activated” portion of the list. If they are of similar duration, this will likely cause “Huy report” to no longer be highlighted, which means there is no time to do that task during the current day. The other way to allocate time for “Trung unfuddle” is for the user to slide the slider bar to the right, increasing the umber of available hours during the day. This informs the user, quickly and easily, how late he or she must work in order to hold all events and complete all highlighted tasks, including “Trung unfuddle.”

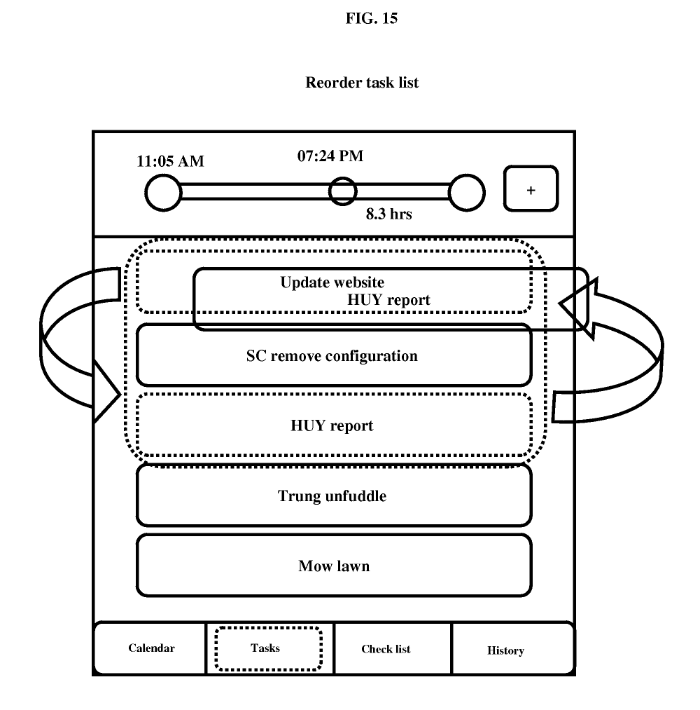

FIG. 15 is a snapshot depicting reordering the task list, according to an embodiment as disclosed herein. The snapshot indicates the view of reordering the tasks. A user may reorder the tasks from the task list in the order of his preferences. The reordering may be done by dragging the task from the list and dropping it at the desired position in the list. For example, if the user wants to reorder the list and place the task at position 1 to position 3 and the task at position 3 to position 1 the user may perform reordering in the manner as depicted in the snapshot. In the snapshot the position of ‘HUY report’ at position 3 is shown in dotted box that indicates that the task ‘HUY report’ is being moved from position 3 and at the task is placed at position 1. In a similar manner, the task ‘update website’ that was at position one is getting replaced by the task ‘HUY report’. The task ‘update website’ is performed after the placement of the task ‘HUY report’ at position 1. Reordering of tasks leads to change in the priority of the tasks and thus with the reordering ‘HUY report’ will be assigned highest priority. Further, the slider on top indicates the available time indicated by the user. The motion of the slider indicates the time that has elapsed since the start time. For example, if the start time is set as 11:05 AM the current position of the slider indicates the current time is 7:24 PM and the total time duration allocated was 8.3 hours. With the reordering of the tasks the integrated calendar has to recalculate the time required for the tasks during the day and also re-allocate the schedules for the tasks based on the updates in their priority.

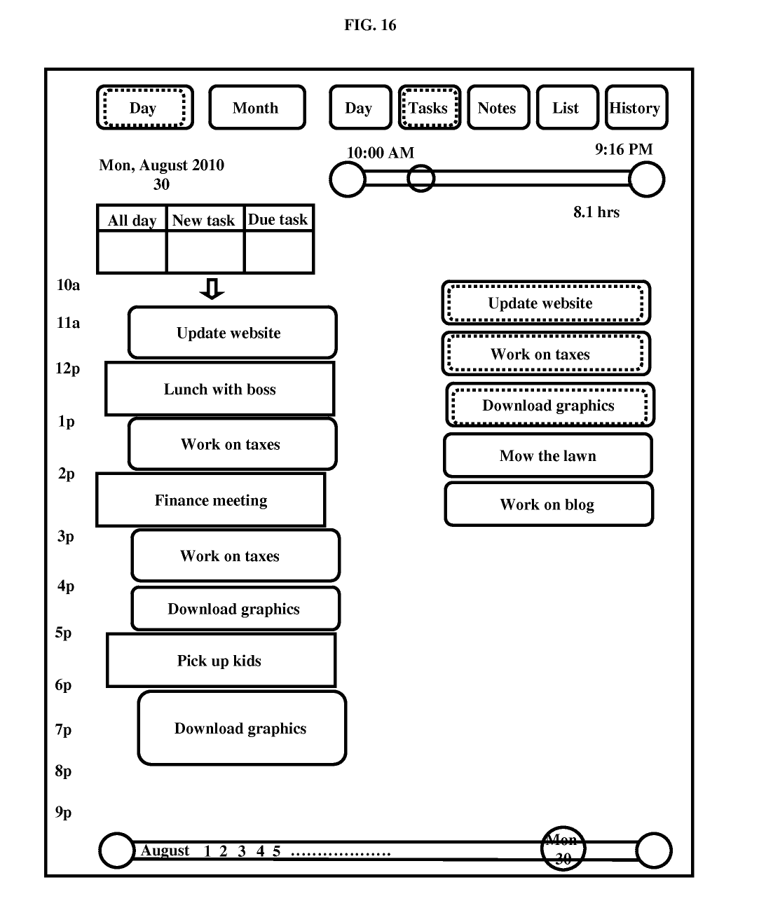

FIG. 16 is a snapshot depicting splitting tasks in between events, according to an embodiment as disclosed herein. The embodiment herein depicts an implementation of day management using an integrated calendar where both the integrated calendar and the task list are shown side by side within the same view. The left of the snapshot indicates the tasks and events that are integrated within the calendar. The right of the snapshot indicates the tasks that have been input into the task list on the integrated calendar application. The task list comprises of tasks input by the user in the order of their priority. The tasks include ‘update website’, ‘work on taxes’ and ‘download graphics’ and so on. Once the tasks are entered on the tasks list, the integrated calendar application determines the free time slot available with the user and which of the tasks may be fit into the free time slot for the day. The free time slot is determined by subtracting the time allocated for events from the available time for the day with the user. As depicted in the snapshot, the events ‘lunch with boss’, ‘finance meeting’ and ‘pick up kids’ are assigned time. The integrated calendar determines that the task ‘update website’ ‘work on taxes’ and ‘download graphics’ may be accommodated in the available free time slots of the user for the day i.e., in between the events assigned for the day. Further, tasks such as ‘work on taxes’ and ‘download graphics’ cannot be accommodated in a single free time slot since the time required for the completion of theses tasks is more that the time available in the time slot. As a result, the tasks are split into different time slots available during the day for completion. For example, the task ‘work on taxes’ requires 2 hours for completion and is split into two time slots and accommodated into the time slots between 1 PM to 2 PM and 3 PM to 4 PM. On similar lines, the task ‘download graphics’ requires 3 hours for completion and is allocated time slots 4 PM to 5 PM and 6 PM to 8 PM. In a similar manner, any other tasks may be split into multiple small tasks and allocated in the free time slots available for the day. Other tasks from the task list cannot be allocated time slots in the free time available for the day and hence they are indicated as faded in the task list. In an embodiment, the faded tasks in the task list may be fit into the free time available in the day provided the order of the tasks in the task list is altered. The tasks that can be fit into the available time slots are highlighted as depicted in the task list.

The embodiments disclosed herein can be implemented through at least one software program running on at least one hardware device.

The embodiments disclosed herein may be implemented on a device that supports the integrated calendar application. The device may include a computer device such as a laptop, desktop, tablet and the like or a mobile device such as a mobile phone, a smart phone and so on.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for day management using an integrated calendar, said method comprising:
defining amount of time available for work during a period;
checking events already scheduled during said period;
calculating time allocated for said events;
determining time available for performing prioritized tasks based on said scheduled events and said definition of amount of time available;
determining tasks that are to be performed in said time available during said day in order of said priority; and
allocating said tasks that are to be performed during said period in said order of priority.

2. The method as in claim 1, wherein said method further comprises of splitting said task into multiple tasks if said task cannot be performed in said time available time during said period.

3. The method as in claim 1, wherein said method further comprises of recalculating time available for performing said prioritized tasks and assigning said tasks when a user updates task list.

4. The method as in claim 1, wherein said method further comprises of reallocating said tasks for said period when a user updates task list.

5. The method as in claim 1, wherein said period is one of day, multiple days, week or month.

6. The method as in claim 1, wherein said method further comprises of prioritizing said tasks based on the order of said tasks as entered, filtered or sorted by a user in said task list.

7. The method as in claim 1, wherein said method further comprises of a user defining duration of said tasks by entering a duration time for said task by overriding the default time for said tasks provided in said task settings.

8. The method as in claim 1, wherein said method further comprises of a user defining duration of said tasks by selecting default time for said tasks provided in said task settings.

9. The method as in claim 1, wherein said method further comprises of determining time available for performing prioritized task by subtracting time allocated for events from time available during said period.

10. The method as in claim 1, wherein said method further comprises of said user defining said time period and time duration for said tasks through one of:
using a slider;
selecting the options; and
entering a default option.

11. A computer system for day management using an integrated calendar, said system adapted with at least one means for:
defining the amount of time available for work during a period by a user;
checking events already scheduled by said user for said period;
determining time available for performing prioritized task based on said scheduled events;
determining tasks that are to be performed in said time available during said day in order of said priority; and
allocating said tasks that are to be performed during said period in said order of priority.

12. The computer system as in claim 11, wherein said system is further adapted with means for splitting a task into multiple tasks if said task cannot be performed in said time available in said period.

13. The computer system as in claim 11, wherein said system is further adapted with means for recalculating time available for performing said prioritized tasks and assigning said tasks when said user updates task list.

14. The computer system as in claim 11, wherein said system is further adapted for reallocating said tasks for said period when said user updates task list.

15. The computer system as in claim 11, wherein said system is further adapted for determining time available for performing prioritized task by subtracting time allocated for events from time available during said period.

16. The computer system as in claim 11, wherein said system is further adapted for prioritizing said tasks based on the order of said tasks as entered by said user in said task list.

17. The computer system as in claim 11, wherein said period is one of day, week or month.

18. The computer system as in claim 11, wherein said system is further adapted for defining duration of said tasks by entering a duration time for said task by overriding the default time for said tasks provided in said task settings.

19. The computer system as in claim 11, wherein said system is further adapted for defining duration of said tasks by selecting default time for said tasks provided in said task settings.

20. The computer system as in claim 11, wherein said system is further adapted for defining said time period and time duration for said tasks through one of
using a slider;
tapping on the options; and
entering an option.

21. A computer program product for day management using an integrated calendar, said product comprising:
defining amount of time available for work during a period;
checking events already scheduled during said period;
calculating time allocated for said events;
determining time available for performing prioritized task based on said scheduled events;
determining tasks that are to be performed in said time available during said period in order of said priority; and
allocating said tasks that are to be performed during said period in said order of priority.

22. The computer program product as in claim 21, wherein said product further comprises of splitting said task into multiple tasks if said task cannot be performed in said time available time during said period.

23. The computer program product as in claim 21, wherein said product further comprises of recalculating time available for performing said prioritized tasks and assigning said tasks when a user updates task list.

24. The computer program product as in claim 21, wherein said product further comprises of reallocating said tasks for said period when a user updates task list.

25. The computer program product as in claim 21, wherein said product further comprises of prioritizing said tasks based on the order of said tasks as entered by said user in said task list.

26. The computer program product as in claim 21, wherein said period is one of day, week or month.

27. The computer program product as in claim 21, wherein said product further comprises of a user defining duration of said tasks by entering a duration time for said task by overriding the default time for said tasks provided in said task settings.

28. The computer program product as in claim 21, wherein said product further comprises of a user defining duration of said tasks by selecting default time for said tasks provided in said task settings.

29. The computer program product as in claim 21, wherein said product further comprises of said user defining said time period and time duration for said tasks through one of:
using a slider;
tapping on the options; and
entering an option.

30. The computer program product as in claim 21, wherein said product further comprises of determining time available for performing prioritized task by subtracting time allocated for events from time available during period.
